(19) United States
(12) Patent Application Publication
(10) Pub. No.: US 2010/0027853 A1
(43) Pub. Date: Feb. 4, 2010

(54) IMAGE ENCRYPTION SYSTEM AND METHOD FOR AUTOMATICALLY ENCRYPTING IMAGE OF AT LEAST PARTIALLY NUDE PERSON AND DIGITAL IMAGE CAPTURE DEVICE HAVING SAME

(75) Inventor: WU-SHENG WEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,421

(22) Filed: Dec. 9, 2008

(30) Foreign Application Priority Data
Jul. 31, 2008 (CN) 200810303246.0

(51) Int. Cl. G06K 9/00; G09C 5/00

(52) U.S. Cl. 382/118; 380/54

(57) ABSTRACT

An encryption method includes: recognizing any face included in an image; analyzing color(s) of the recognized face(s) and thereby determining skin-color(s) of person(s) included in the image; determining a skin-area using the determined skin-color(s); calculating a ratio of the area of the recognized face(s) to the determined skin-area, and determining whether the image required to be encrypted based upon the calculated ratio; and encrypting the image in response to the inputs of a user if the image is required to be encrypted.

### BACKGROUND

1. Technical Field

The present disclosure relates to encryption systems and, particularly, to an image encryption system and method capable of automatically recognizing and encrypting an image having at least partially nude person(s) and a digital image capture device using the same.

2. Description of the Related Art

It is not uncommon for people record their intimate moments as photos. These photos are of an extremely private nature and should be kept secure from others. This task can be accomplished by many current encryption methods. However, the current encryption methods are typically accomplished manually. For example, when using a current encryption method to encrypt photos during shooting or reviewing of the photos, a user needs to check the photos one by one to decide which should be encrypted and which can be shared with others. This task is very inconvenient or difficult for the user to perform on a consistent basis.

Therefore, it is desirable to provide an image encryption system and method, and a digital image capture device using the same, which can overcome the above-mentioned problem.

### BRIEF DESCRIPTION OF THE DRAWINGS

FIG. 1 is a functional block diagram of a digital image capture device which includes a skin-color analysis unit, according to an exemplary embodiment.

FIG. 2 is a table showing an analysis result of the skin-color analysis unit of FIG. 1.

FIG. 3 is a table showing a weight matrix used by the skin-color analysis unit of FIG. 1.

FIG. 4 is a table showing another analysis result of the skin-color analysis unit of FIG. 1.

FIG. 5 is a flowchart of an image encryption method, according to another exemplary embodiment.

### DETAILED DESCRIPTION OF THE EMBODIMENTS

Embodiments of the present digital image capture device, image encryption system and method will now be described in detail with references to the accompanying drawings. In the following described embodiments, the image encryption system and method are used in the digital image capture device. However, it should be noted that applications of the image encryption system and method are not limited to the digital image capture device as described in the current disclosure, but also can be used in any other electronic device, such as a computer or a mobile phone.

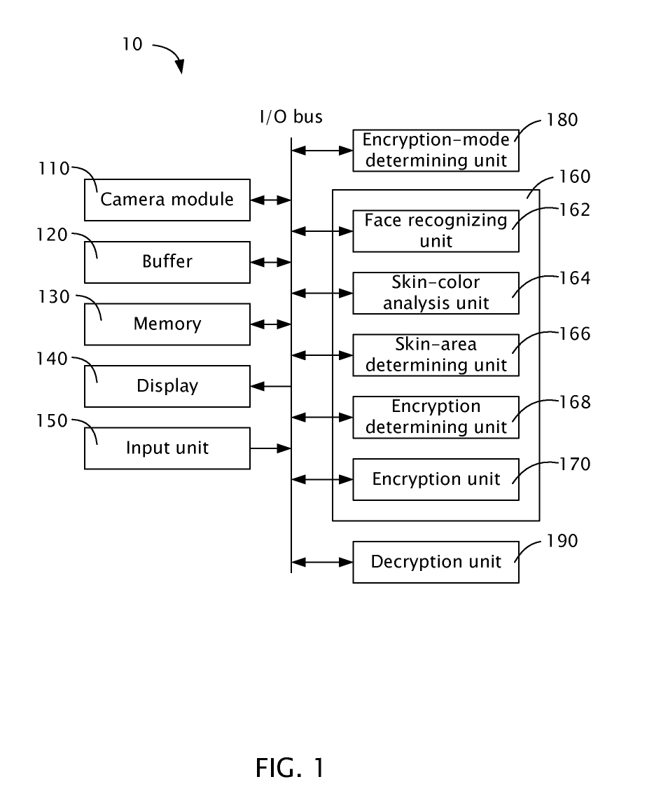

Referring to FIG. 1, a digital image capture device 10 in accordance with an exemplary embodiment includes a camera module 110, a buffer 120, a memory 130, a display 140, an input unit 150, an image encryption system 160, an encryption-mode determining unit 180, and a decryption unit 190.

The camera module 110 includes a lens, an image sensor, required controlling units, and various image processing units (not shown). The lens is configured for forming an optical image on the image sensor. The image sensor, such as a charge-coupled device (CCD) is configured for converting the optical image into corresponding electrical signals. The controlling units may include an auto-focus controlling unit, an auto-exposure controlling unit and an auto-white-balance controlling unit and are configured for controlling corresponding aspects of the camera module 110. The image processing units may include a color space converting unit, a gamma correcting unit, and a JPEG encoding unit and are configured for processing the electrical signals for various intends to finally output a corresponding image.

The buffer 120 is for buffering data being processed for the digital image capture device 10.

The memory 130 is for storing images formed by the camera module 110 or transmitted from other external storage devices.

The display 140 such as a liquid crystal display is configured for displaying image(s) and interactive information, e.g., a cipher input window and a key input window (see below), for a user. The input unit 150 such as a keypad is configured for receiving inputs of the user. The display 140 and the input unit 150 constitute a user interface of the digital image capture device 10. In other alternative embodiments, the display 140 and the input unit 150 can be integrated into a touch-screen.

The image encryption system 160 is configured for determining whether an image includes any at least partially nude person (hereinafter, nude person) and encrypting the image if at least one nude person is included in the image in response to the inputs of the user. The image can be read directly from the camera module 110 or alternatively read from the memory 130, and buffered in the buffer 120.

The image encryption system 160 includes a face recognition unit 162, a skin-color analysis unit 164, a skin-area determining unit 166, an encryption determining unit 168, and an encryption unit 170. The face recognition unit 162 is configured for recognizing if any human face is included in an image. The skin-color analysis unit 164 is configured for measuring color(s) of the found face(s) and accordingly determining skin-color(s) of the person(s) included in the image. The skin-area determining unit 166 is configured for determining exposed skin-area of the image using the determined skin-color(s). The encryption determining unit 168 is configured for determining whether the image should be encrypted or not based on a ratio of the area of the found face(s) to the determined exposed skin-area. For example, if the ratio is smaller than 1:10, then the encryption determining unit 168 determines that the person(s) in the image has too much exposed skin and the image should be encrypted. Otherwise, the encryption determining unit 168 determines the image can be stored without encryption. The encryption unit 170 is configured for encrypting the image in response to the inputs of the user.

For the face recognition unit 162, many face recognition algorithms, including nerve network, nerve network plus fast Fourier transform, fuzzy plus nerve network, RGB normalized color, fuzzy color, principle component analysis, and algorithm template, can be used to detect face(s) in the image.

If any face is detected by the face recognition unit 162, the skin-color analysis unit 164 is activated, and starts to measure the color(s) of the recognized face(s). In detail, statistical methods can be used to find out what color a face is. Commonly, each pixel of the image is represented by three pixel values: red (R), green (G) and blue (B). Each pixel value is an 8-bit data. That is, the image is represented by three color components: R, G and B. Each color component is digitized into 256 levels, e.g., 0-255. Accordingly, for a face, the skin-color analysis unit 164 can count the number of pixels of each pixel value, and take the pixel value of the most pixels as the pixel value of the face in a corresponding color component.

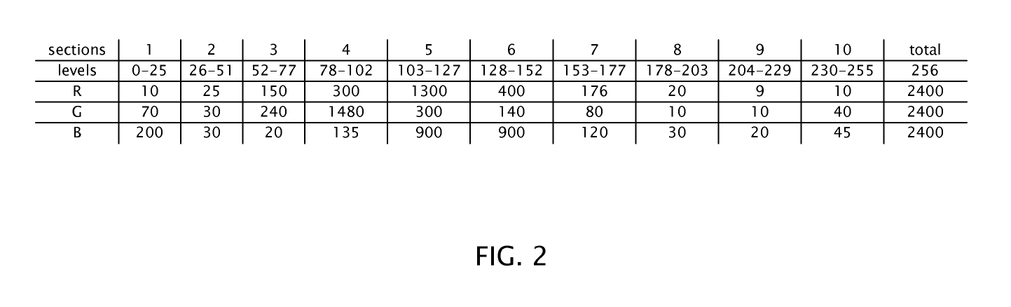

In reality, the color of the face is not uniform and varies within a certain color range. Accordingly, referring to FIG. 2, in this embodiment, the 256 levels of each color component are subdivided into ten sections: sections 1-3 and 8-10 each having 26 levels and sections 4-7 each having 25 levels. The skin-color analysis unit 164 counts the number of pixels of each section and takes the color range corresponding to the section of the most pixels as the color range of the face in a corresponding color component. As shown in FIG. 2, in an example, the portion of the image containing the face consists of 2400 pixels. The colors of the face can be represented by: R: 103-127; G: 78-102; and B: 103-152.

Generally, being limited by the accuracy of the face recognition unit 162, a portion of the image near the face (hereinafter, the non-facial portion) may be included in the found face(s). The skin-color analysis unit 164 may then be fooled by the non-facial portion and therefore cannot accurately measure the real color(s) of the face. Accordingly, an enhancement technique is required to increase the rate of real color range measurement. In this embodiment, a weight function is used.

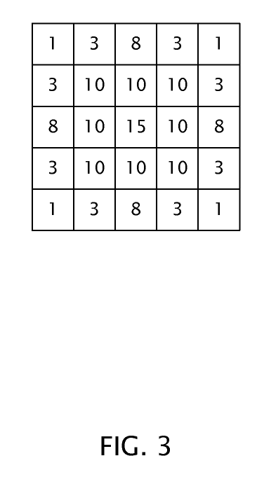

Referring to FIG. 3, an example of a weight matrix used by the skin-color analysis unit 164 is shown. Each element of the weight matrix is used to weight the number of pixels of a corresponding portion of the face(s). For example, as shown in the FIG. 3, a pixel in a central portion corresponding to the element of value 15 will be counted as 15 pixels by the skin-color analysis unit 164.

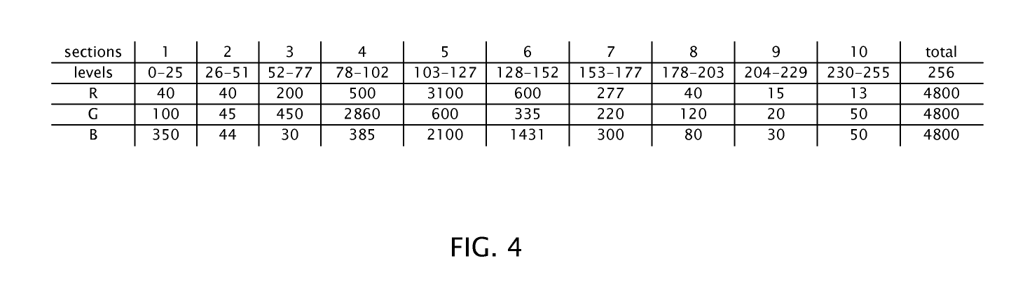

After weighting, the analysis result shown in the table of FIG. 2 is changed to the table shown in the FIG. 4. From the table of FIG. 4, it can be inferred that detection of a color range more closely representative of the real color(s) of a face is obtained, as compared with the table of FIG. 2. In particular, the skin-color analysis unit 164 can determine that section 5, not section 6, of B color component better represents the true colors of the face. But this cannot be accomplished without the weighting function. Accordingly, the real colors of the face should be represented by: R: 103-127; G: 78-102; and B: 103-127.

It should be noted that the weight matrix is just an example. Also, the color analysis capacity of the color analysis unit 164 is not limited to a RGB color space. Alternatively, the color analysis unit 164 should be capable of analyzing color of the image in other color space such as YUV or YCrCb color space, where Y represent a luminance component, U and V are chrominance components, and Cb and Cr are blue-different and red-different chrominance components respectively.

The skin-area determining unit 166 classifies pixels of the image into two categories: skin-area and non-skin area, using the skin-color(s), e.g., the R, G and B color ranges. The skin-area has color values similar to the determined skin-color(s). Accordingly, the left area of the image is non-skin area. In particular, the skin-area determining unit 166 can read pixel values of each pixel and compares the read pixel values with corresponding color ranges. If all pixel values are in a corresponding color range, the pixel is classified to the skin-area. If not, the pixel belongs to the non-skin area.

The encryption determining unit 168 calculates the ratio of an area of the face(s) to the skin-area, and thereby determines whether the image includes nude person(s). Commonly, in a portrait of a human being with total nudity, the ratio of the area of the face to that of the body should be in a reasonable range, e.g., 1/19-1/15. Therefore, once the ratio of the face(s) to the skin-area is calculated, the encryption determining unit 168 can estimate how much portion of body(s) of the person(s) in the image is nude. For example, if the ratio of the area of face(s) to that of the skin-area is smaller than 1/10, it can be assumed that the person(s) of the image have too much skin exposed and, accordingly, the image should be encrypted.

If the encryption determining unit 168 determines that the image needs to be encrypted, the encryption unit 170 is activated. Consequently or meanwhile, a cipher input window (not shown) is generated by the encryption unit 170 and displayed by the display 140 to warn the user to input a cipher via the input unit 150. After the cipher is entered, the encryption unit 170 starts to encrypt the image using the cipher. Then the encrypted image can be stored in the memory 130.

The encryption system 160 can automatically encrypt an image. Therefore, the task of encryption of images of nude person(s) which are mixed with some non-sensitive images can be performed on a consistent basis.

The encryption system 160 can function as an auto-encryption mode which is provided by the digital image capture device 10. Also, in addition to this auto-encryption mode, the digital image capture device 10 can further provide, for example, a non-encryption mode and a high-level encryption mode. In particular, if the non-encryption mode is selected, all images buffered in the buffer 120 will be stored to the memory 130 without encryption. If the high-level encryption mode is activated, all images buffered in the buffer 120 will be encrypted without detection of nude person(s) and then stored in the memory 130. In order to allow the user to select a desired encryption mode, an encryption-mode determining unit 180 is provided. The encryption-mode determining unit 180 is capable of determining the encryption mode of the digital image capture device 10 in response to the inputs of the user via the input unit 150.

In order to allow the user to review the encrypted images, the digital image capture device 10 further includes a decryption unit 190. The decryption unit 190 is configured for decrypting encrypted image(s) in response to the inputs of the user (see below).

Various components of the digital image capture device 10 such as the encryption system 160, the encryption-mode determining unit 180, and the decryption unit 190 can be individual electrical elements, or alternatively integrated into a central control unit. The components can connect to each other by an input/output (I/O) bus. Also, some components can be software modules written in a variety of computer languages such as C#, Visual C++, Visual Basic, C++, and so on.

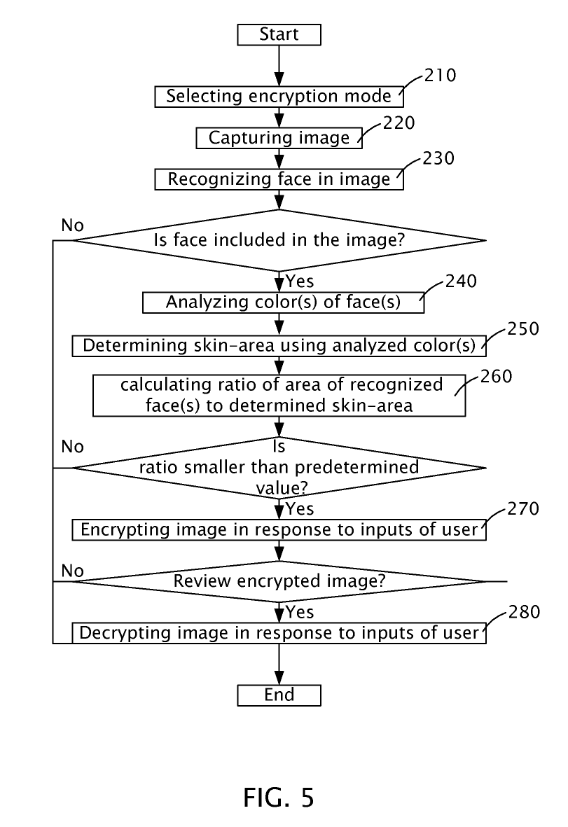

Referring to FIG. 5, an image encryption method, according to another embodiment, can be exemplarily implemented by the digital image capture device 10 and includes the following steps 210-280.

Step 210: selecting an encryption mode. In detail, after the digital image capture device 10 is powered on, a mode-selection window (not shown) is displayed on the display 140. The mode-selection window is configured for selecting an encryption mode of the digital image capture device 10 in response to the inputs of the user. Meanwhile, the encryption-mode determining unit 180 is activated, receives the selection of the encryption mode and determines which encryption mode will be used by the digital image capture device 10.

For example, for landscape images, the user can choose the non-encryption mode, and all images will be stored to the memory 130 without encryption. For extremely sensitive images, the high-level encryption mode is desired, and all images will be encrypted before stored to the memory 130. For a situation that some of images are desired to be shared with other people but some are required to be encrypted, if the encryption of these images is implemented manually, the user may miss some of the images required to be encrypted. Therefore, the auto-encryption mode is preferred. In this embodiment, the auto-encryption mode is chosen. When the auto-encryption mode is chosen, the encryption system 160 is activated.

Step 220: capturing an image or alternatively reading the image from the memory 130. The image is buffered in the buffer 120.

Step 230: recognizing any human face included in the image. This step can be carried out by the face recognition unit 162.

Step 240: analyzing color(s) of the recognized face(s) and thereby determining skin-color(s) of person(s) included in the image. This step can be carried out by the skin-color analysis unit 164.

Step 250: determining a skin-area using the determined skin-color(s). This step can be carried out by the skin-area determining unit 166.

Step 260: calculating a ratio of the area of the recognized face(s) to the determined skin-area, and determining whether the image need to be encrypted based upon the calculated ratio. This step can be carried out by the encryption determining unit 168.

Step 270: encrypting the image based upon the determination provided by the encryption determining unit 168 in response to the inputs of the user via the input unit 150. This step can be carried out by the encryption unit 170. In particular, when the encryption is required, the encryption unit 170 generates a cipher input window (not shown) for receiving a cipher for encrypting the digital image.

Step 280: decrypting the encrypted image in response to the inputs of the user. In detail, when the user wishes to review the encrypted image(s), he can trigger a key input window (not shown) via menu(s) of the digital image capture device 10. The key input window is configured for receiving a key in response to the inputs of the user via the input unit 150. Consequently, the decryption unit 190 can decrypt the encrypted image(s) using the key.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. An image encryption system comprising:
a face recognition unit configured for recognizing a face included in an image;
a skin-color analysis unit configured for measuring color(s) of the recognized face(s) and accordingly determining skin-color(s) of person(s) included in the image;
a skin-area determining unit configured for determining skin-area of the image using the determined skin-color(s);
an encryption determining unit configured for determining whether the image should be encrypted or not based on a ratio of the area of the recognized face(s) to the determined skin-area; and
an encryption unit 170 configured for encrypting the image, if the image is required to be encrypted.

2. The image encryption system as claimed in claim 1, wherein the face recognition unit recognizes the face(s) uses a face recognition algorithm selected from the group consisting of nerve network, nerve network plus fast Fourier transform, fuzzy plus nerve network, RGB normalized color, fuzzy color, principle component analysis, and algorithm template.

3. The image encryption system as claimed in claim 1, wherein the skin-color analysis unit measures skin-color(s) using a statistical method.

4. The image encryption system as claimed in claim 1, wherein each pixel of a face in the image represented by three pixel values in three corresponding color components, the skin-color analysis unit counts the number of pixels of each pixel value, and taking the pixel value of the most pixels as the pixel values of the face in a corresponding color component.

5. The image encryption system as claimed in claim 4, wherein the skin-color analysis unit weights the number of the pixels of the face using a weight matrix before counting, a pixel of a portion of the face corresponding to a corresponding element of the weight matrix being counted as N pixels, where N is the value of the corresponding element.

6. The image encryption system as claimed in claim 1, wherein each face is represented by three color components each of which has a predetermined levels, the skin-color analysis unit subdivides the levels into a predetermined sections, counts the number of pixels of each section, and takes the color range corresponding to the section of most pixels as the color range of the face in a corresponding color component.

7. The image encryption system as claimed in claim 4, wherein the skin-color analysis unit weights the number of the pixels of the face using a weight matrix before counting, a pixel of a portion of the face corresponding to a corresponding element of the weight matrix is counted as N pixels, where N is the value of the corresponding element.

8. The image encryption system as claimed in claim 1, wherein the skin-area determining unit determines the skin-area by comparing pixel values of each pixel of the image with analyzed skin-color(s), if pixel values of a pixel are similar to the analyzed skin-color(s), the pixel is determined belonging to the skin-area.

9. A digital capture device comprising:
a camera module for capturing an image;
a buffer for buffering the image;
a memory for storing the image; and
an encryption system comprising:
a face recognition unit configured for recognizing a face included in the image;
a skin-color analysis unit configured for measuring color(s) of the recognized face(s) and accordingly determining skin-color(s) of person(s) included in the image;
a skin-area determining unit configured for determining skin-area of the image using the determined skin-color(s);
an encryption determining unit configured for determining whether the image should be encrypted or not based on a ratio of the area of the recognized face(s) to the determined skin-area; and
an encryption unit 170 configured for encrypting the image, if the image is require to be encrypted.

10. The digital image capture device as claimed in claim 9, wherein the image encryption system is capable of being activated by a encryption mode selection provided by the digital image capture device, the digital image capture device further comprises an encryption-mode determining unit configured for selecting a encryption mode of the digital image capture device.

11. The digital image capture device as claimed in claim 9, further comprising a decryption unit configured for decrypting an encrypted image.

12. The digital image capture device as claimed in claim 9, further comprising a display for displaying the image and interactive information for the user.

13. The digital image capture device as claimed in claim 9, further comprising an input unit for receiving inputs of the user.

14. An image encryption method comprising: recognizing a face included in an image;
analyzing color(s) of the recognized face(s) and thereby determining skin-color(s) of person(s) included in the image;
determining a skin-area using the determined skin-color(s);
calculating a ratio of the area of the recognized face(s) to the determined skin-area, and determining whether the image required to be encrypted based upon the calculated ratio; and
encrypting the image, if the image is required to be encrypted.

15. The image encryption method as claimed in claim 14, further comprising:
selecting an auto-encryption mode before the step of recognizing, the auto-encryption mode being configured for triggering the implementation of the steps of recognizing, analyzing, determining, calculating and encrypting.

16. The image encryption method as claimed in claim 14, wherein the step of recognizing uses a face recognition algorithm selected from the group consisting of nerve network, nerve network plus fast Fourier transform, fuzzy plus nerve network, RGB normalized color, fuzzy color, principle component analysis, and algorithm template.

17. The image encryption method as claimed in claim 14, wherein the step of analyzing uses a statistical method.

18. The image encryption method as claimed in claim 14, wherein each pixel of a face in the image represented by three pixel values in three corresponding color components, the step of analyzing comprising:
counting the number of pixels of each pixel value, and
taking the pixel value of the most pixels as the pixel values of the face in a corresponding color component.

19. The image encryption method as claimed in claim 18, further comprising:
weighting the number of the pixels of the face using a weight matrix before the step of counting, a pixel of a portion of the face corresponding to a corresponding element of the weight matrix being counted as N pixels during the step of counting, where N is the value of the corresponding element.

20. The image encryption method as claimed in claim 14, further comprising: decrypting the encrypted image.
